(19) United States
(12) Patent Application Publication
(10) Pub. No.: US 2013/0200645 A1
(43) Pub. Date: Aug. 8, 2013

(54) ADAPTABLE VEHICULAR STORAGE SYSTEM

(71) Applicants: Richard Miller, Brentwood, TN (US); Tim Franklin, Franklin, TN (US)

(72) Inventors: Richard Miller, Brentwood, TN (US); Tim Franklin, Franklin, TN (US)

(73) Assignee: Nissan North America, Inc., Franklin, TN (US)

(21) Appl. No.: 13/368,829

(22) Filed: Feb. 8, 2012

(51) Int. Cl. B60R 9/00; B60R 7/00

(52) U.S. Cl. 296/37.6; 296/37.8

(57) ABSTRACT

Disclosed herein are embodiments of an adaptable vehicular storage system to secure and store cargo items. In one embodiment, a panel is incorporated inside a vehicle which defines at least one vertical surface, and attachment members are selectively positionable to attach cargo items to the panel. The adaptable vehicular storage system can also comprise cargo bins, nets, and rails to allow storage of different cargo items. The different attachment members can be positioned on the panel to customize the storage system to adapt to secure cargo items based on the cargos size and shape, and the vehicles' storage space and location.

### BACKGROUND

People typically use a vehicle for work, perhaps carrying expensive equipment and tools in the vehicle, and/or use a vehicle for personal use, carrying items such as sports equipment, vehicle maintenance equipment, purchases, and the like inside the vehicle. It is desirable to prevent such cargo and items in transit from moving unrestrained throughout a cargo or passenger area of a vehicle. The cargo can be damaged if unrestrained, or pose a potential safety risk to those in the vehicle, even during normal operation of the vehicle. Furthermore, it is desirable to keep items and cargo organized during travel.

Existing storage designs often require a large amount of space in either the cargo or passenger area of cars and trucks, and are not customizable or adaptable based on the cargo for which they are being utilized.

### SUMMARY

Disclosed herein are embodiments of adaptable storage systems for use inside vehicles. In one embodiment, an adaptable vehicular storage system comprises a panel having a planar surface, the panel configured to be positioned within a vehicle with the planar surface being vertically oriented and a plurality of attachment members carried by the panel, and selectively positionable on the panel to retain cargo.

In another aspect, an adaptable vehicular storage system comprises a panel having a planar surface, the panel configured to be positioned in a vehicle with the planar surface being vertically oriented, a plurality of receiving members located on the panel and extending at least partially through the panel and a plurality of attachment members each sized to fit in a respective receiving member. The plurality of attachment members is selectively positionable within the receiving members.

In another aspect, an adaptable vehicular storage system comprises a perforated panel defining at least one surface in a vehicle, the at least one surface being vertically oriented, and the perforated panel having a plurality of holes defined at least partially through the panel. The adaptable vehicular storage system also comprises a plurality of pegs sized to fit in the holes defined in the panel, wherein the pegs are selectively positionable on the perforated panel to attach and retain cargo in the vehicle.

Also disclosed is a vehicle having an internal wall, a panel having a planar surface, the panel attached to the internal wall with the planar surface being vertically oriented and a plurality of attachment members carried by the panel, and selectively positionable on the panel to retain cargo.

These and other aspects will be described in additional detail below.

### BRIEF DESCRIPTION OF THE DRAWINGS

The various features, advantages and other uses of the present system and method will become more apparent by referring to the following detailed description and drawings in which:

FIG. 1 is a front view of an adaptable vehicular storage system showing a panel and attachment members.

FIG. 2A is a top view of an adaptable vehicular storage system showing a panel capable of extending in length, in an extended position.

FIG. 2B is a top view of an adaptable vehicular storage system showing a panel capable of extending in length, in a collapsed position.

FIG. 3 is a perspective view of a vehicle with an adaptable vehicular storage system incorporated therein.

FIG. 4 is a perspective view of a pickup truck, showing an adaptable vehicular storage system incorporated the pickup bed.

FIG. 5 is a front view of an adaptable vehicular storage system showing a panel, rails, attachment members, and cargo bins.

FIG. 6 is a front view of an adaptable vehicular storage system showing a panel, holes, attachment members, and a cargo bin.

FIG. 7 is a front view of an adaptable vehicular storage system showing a panel, attachment members, cargo bins, and nets.

### DETAILED DESCRIPTION

Disclosed herein are embodiments of a vehicular storage system to secure cargo in a vehicle which is adaptable and customizable to different size cargo items and cargo space in a vehicle. The term “vehicle” is used herein generally to describe a vehicle or other road going or off-road motive device that is used to transport people and cargo. The term “cargo” is used herein generally to describe any item or items transported in a vehicle.

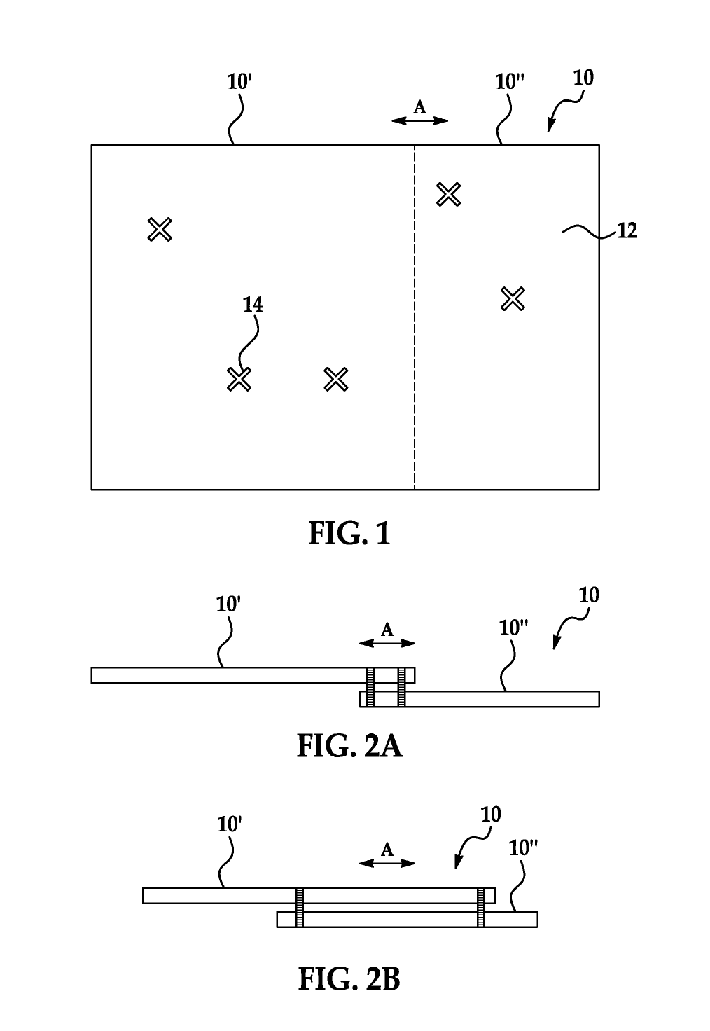

FIG. 1 illustrates a panel 10 which defines a substantially planar surface 12. The panel 10 is configured to be positioned in a vehicle with the planar surface 12 being vertically orientated with respect to the vehicle. As used herein, “planar surface” includes surfaces which are substantially planar, or generally planar overall but with some non-planar surface variations. Panel 10 with surface 12 can be incorporated in a vehicle in several locations, and in several ways. Attachment members 14 are selectively positionable on the panel 10 and can be used to secure and store a variety of different cargo items.

The panel 10 can be made of any material suitable for application within a vehicle known to those skilled in the art. As non-limiting examples, the panel 10 can consist of wood, plastic, metal and any combination thereof. The panel 10 may be all or partially magnetic. The panel 10 may have fixed dimensions for universal use and placement in a vehicle. As a non-limiting example, the panel 10 can be square or rectangular with a fixed width, height and depth that will fit in a plurality of locations within the vehicle. The panel 10 can have fixed dimensions that are particularly suitable for a particular vehicle or particular location within a vehicle. As a non-limiting example, the panel 10 can be rectangular with a fixed width, height and depth that will fit along an internal side of a cargo bed of a truck.

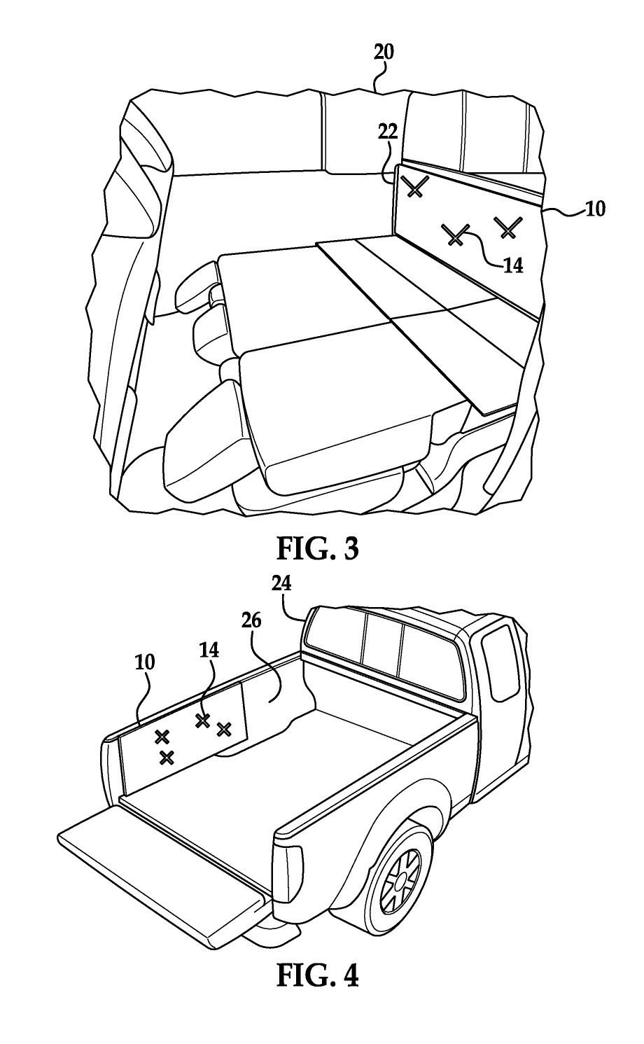

The panel 10 can have at least one flexible dimension, selectively adaptable in size or shape. By altering the dimensions of the panel 10, the panel 10 can be sized to fit in a variety of locations on the vehicle. For example, the flexible dimension can be the width of the panel 10, with the width being lengthened or shortened along its width in a telescopic. In this example, the panel 10 is made of two panels 10′ and 10″ and can be extended in a telescopic manner as shown by arrow A, illustrated in FIG. 1. FIGS. 2A and 2B are top views of the panels 10′, 10″ with the panel 10 lengthened in FIG. 2A and shortened in FIG. 2B. As a non-limiting example, the panel 10 can be shortened to fit within the passenger compartment of a truck or lengthened to fit along the bed of a truck bed.

The panel 10 may be located and attached to the vehicle in a variety of locations, including any area inside a vehicle which provides a substantially vertical support surface. The panel 10 may be attached to the vehicle by any means known to those skilled in the art, such as fastening the panel 10 to a surface inside a vehicle using any known fastener. The panel 10 may be installed as an aftermarket vehicle accessory, or the panel 10 with surface 12 may be integrated in the vehicle before sale. As shown in FIG. 3, the panel 10 may be incorporated in a pickup truck cab 20 on the rear wall 22 below the rear window, and can be accessible either when the seats are folded down, or can be implemented with the option to remove the rear most row of seats altogether. Referring now to FIG. 4, the panel 10 may be incorporated on the inside of the wall 26 of a pickup truck 24 cargo bed. The attachment members 14 may then be selectively positioned on the panel 10 to secure and attach cargo in the bed of a pickup truck 24. It is further contemplated that a vehicle panel could be the panel 10 and the attachment members 14 connected directly to the vehicle panel.

Attachment members 14 can be any members which allow attachment of cargo items to the panel 10. The selectively positionable attachment members 14 allow a customizable storage system that can adapt to the size and shape of the cargo being transported, along with the space available inside the vehicle. The attachment members 14 can include hooks, pins, pegs, magnets, Velcro®, suction, clips or any other member capable of fixing items to the panel 10. The attachment members 14 can connect cargo directly to the panel 10, or can connect via fasteners 15 to the cargo items. The attachment members 14 can include receiving members, or apertures, sized to selectively receive pegs, hooks, pins or the like inserted into the apertures as desired by a user. The attachment members 14 are selectively positionable on the panel 10, such that a varying amount of attachment members 14 may be utilized, and the location of each attachment member 14 can be selected from many possible locations on the panel 10. This allows users great flexibility to allow the attachment members 14 to be placed in different locations adapting the storage system to secure particular items of cargo. One non-limiting example can be where the attachment members 14 are hooks, and are positioned on the panel 10 in certain ways to hold certain areas of tools in transit. Another example can include pins as the attachment members 14 to surround and hold cargo in place against the panel 10. The attachment members 14 can be preexisting and fixed to the panel 10 allowing the option to use different attachment members 14 to use to secure cargo items to the panel 10. The attachment members 14 may further be preexisting and equally spaced on the panel 10.

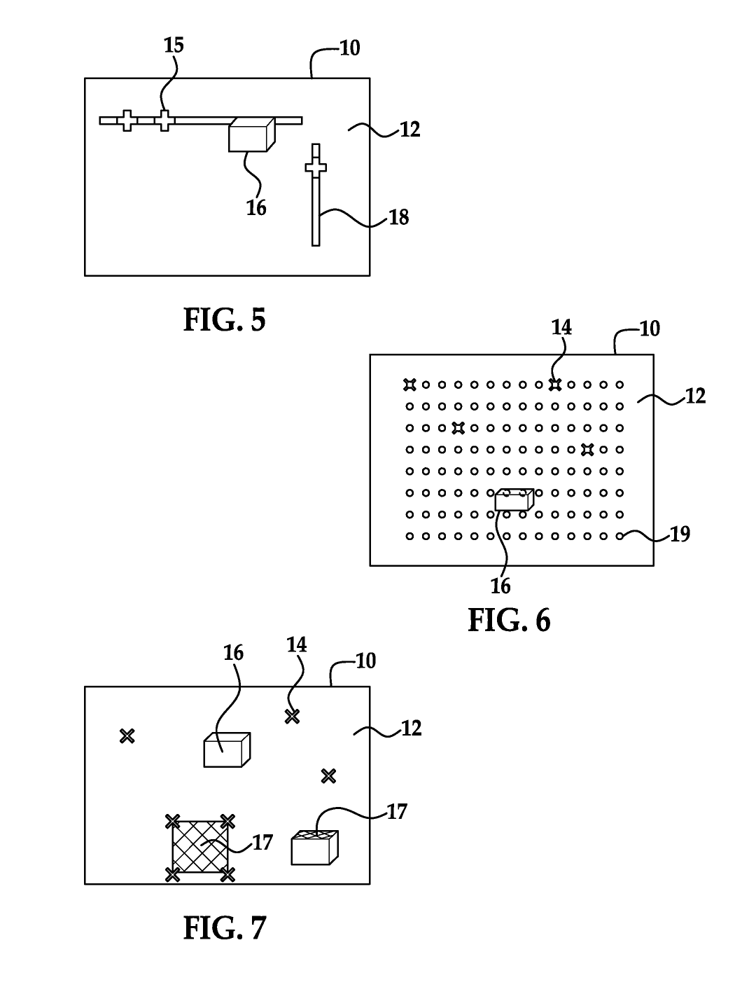

The attachment members 14 in the adaptable vehicular storage system can be rails 18 as illustrated in FIG. 5, which can be either fixed or movably mounted to the panel 10. The rails 18 can be of any material practical for the application and known to those skilled in the art. The rails 18 can have one or more fasteners 15 on the rails 18 to attach cargo items to the rails 18. The fasteners 15 can be moved along the rails 18, so that the cargo items can be selectively attached to the panel 10. Furthermore, the fasteners 15 can either be removable or non-removable from the rails 18. The rails 18 can also be tracks, such that the fasteners clip into the track and are either fixed or movable along the track to selectively position the fasteners.

Referring to FIG. 6, the panel 10 of the adaptable vehicular storage system can have a plurality of holes 19 on the surface 12. The holes can be partially created through the panel 10, or can extend through the thickness of the panel 10. Attachment members 14 are shaped to fit into the holes 19 and are selectively positionable on panel 10 through the plurality of holes 19. The attachment members 14 can have an end which is designed to fit inside one of the plurality of holes 19, or configured to attach to the panel 10 by extending through the panel 10. As FIG. 6 further illustrates, cargo bins 16 can again be selectively attached to the panel 10 using attachment members 14. One non-limiting example can include a perforated panel 10 with a series of uniform plurality of holes 19 through the panel 10, and attachment members 14 would be pegs sized to fit in the plurality of holes 19. The pegs could for instance, have hooks on the end to hold cargo items, or cylindrical pegs placed in the panel 10 selectively around cargo items to secure them to the panel 10.

Cargo bins 16 and nets 17 can also be utilized on the panel 10 through attachment members 14. As shown in FIG. 5-7, cargo bins 16 may be included in the adaptable vehicular storage system. The cargo bins 16 can be selectively positionable on the panel 10 using attachment members 14. The cargo bins 16 can be produced from a variety of materials known to those with skill in the art. Furthermore, the cargo bins 16 can be a variety of different sizes depending on the intended application. The cargo bins 16 can be placed on panel 10 in different configurations to allow a user to hold different sized items of cargo in the cargo bins 16. In one non-limiting example, cargo bins 16 are held to the panel 10 using attachment members 14 which are hooks on both ends, to attach to the panel 10 and cargo bins 16. In another example, the cargo bins 16 can be shaped to attach to attachment members 14 which are apertures in the panel 10. The cargo bins 16 can be utilized while other attachment members 14 hold other cargo items as well. In one aspect, cargo bins 16 can be selectively attached to the rails 18 through fasteners 15, as illustrated by FIG. 5.

Nets 17 can be utilized in the adaptable vehicular storage system. The nets 17 may be attached directly to the panel 10 by attachment members 14 to retain cargo items against the panel 10 or on the attachment members 14 during travel, as shown in FIG. 7. Cargo items can also actually be help to the panel 10 by the net 17. The net 17 can be of any size, and may be sized to cover the entire panel 10. More than one net 17 may be used on a panel 10. The nets 17 may also be used to cover the opening on a cargo bin 16 to secure cargo within the cargo bin 16, also shown in FIG. 7.

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An adaptable vehicular storage system comprising:
a panel having a planar surface, the panel configured to be positioned within a vehicle with the planar surface being vertically oriented; and
a plurality of attachment members carried by the panel, and selectively positionable on the panel to retain cargo.

2. The adaptable vehicular storage system of claim 1, wherein at least one dimension of the panel is adjustable to allow for use in a plurality of locations in the vehicle.

3. The adaptable vehicular storage system of claim 1, wherein the vehicle is a truck and the panel is configured to be positioned behind a rear-most row of seats in a cab of the truck.

4. The adaptable vehicular storage system of claim 1, wherein the vehicle is a truck and the panel is configured to be positioned on a side of a bed of the truck.

5. The adaptable vehicular storage system of claim 1, further including one or more cargo bins, each cargo bin selectively attachable to the panel with one or more of the attachment members.

6. The adaptable vehicular storage system of claim 1, further including one or more cargo bins, each cargo bin comprising a fastener, wherein the plurality of attachment members are apertures configured to receive the fastener.

7. The adaptable vehicular storage system of claim 5, further comprising at least one cargo net wherein the cargo net is configured to attach to the cargo bin to secure cargo in the cargo bin.

8. The adaptable vehicular storage system of claim 1, further comprising at least one cargo net wherein the cargo net is configured to attach to the panel using the plurality of attachment members.

9. The adaptable vehicular storage system of claim 1, wherein the plurality of attachment members comprises one or more rails having a plurality of fasteners movably attached to the rail, wherein the plurality of fasteners are selectively positionable on the rail.

10. The adaptable vehicular storage system of claim 1, wherein the plurality of attachment members comprises one or more of hooks, pegs, magnets, suction or clips.

11. An adaptable vehicular storage system comprising:
a panel having a planar surface, the panel configured to be positioned in a vehicle with the planar surface being vertically oriented;
a plurality of receiving members located on the panel and extending at least partially through the panel; and
a plurality of attachment members each sized to fit in a respective receiving member, the plurality of attachment members selectively positionable within the receiving members.

12. The adaptable vehicular storage system of claim 11, wherein at least one dimension of the panel is adjustable to allow for use in a plurality of locations in the vehicle.

13. The adaptable vehicular storage system of claim 11, wherein the vehicle is a truck and the panel is located behind a rear-most row of seats in a cab of the truck.

14. The adaptable vehicular storage system of claim 11, wherein the vehicle is a truck and the panel is positioned along a side of a truck bed.

15. The adaptable vehicular storage system of claim 11, further including one or more cargo bins, each cargo bin selectively attachable to the panel with one or more of the plurality of attachment members.

16. The adaptable vehicular storage system of claim 11 further comprising one or more cargo bins, each cargo bin comprising at least one of the attachment members each sized to be received in a receiving member.

17. The adaptable vehicular storage system of claim 15 further comprising at least one cargo net wherein the cargo net is configured to attach to the cargo bin to secure cargo within the cargo bin.

18. The adaptable vehicular storage system of claim 11 further comprising at least one cargo net configured to attach to the panel using one or more of the plurality of attachment members.

19. A vehicle comprising:
an internal wall;
a panel having a planar surface, the panel attached to the internal wall with the planar surface being vertically oriented; and
a plurality of attachment members carried by the panel, and selectively positionable on the panel to retain cargo.

20. The vehicle of claim 19, wherein the vehicle is a truck and the internal wall is a side wall of a truck bed.
